(19) United States
(12) Patent Application Publication
(10) Pub. No.: US 2006/0254073 A1
(43) Pub. Date: Nov. 16, 2006

(54) Dual-fan hairdrying apparatus

(76) Inventor: Tim Tao Zhen, Sheung Shui (HK)

Correspondence Address: CONAIR CORPORATION, ONE CUMMINGS POINT ROAD, STAMFORD, CT, 06902, US

(21) Appl. No.: 11/126,765

(22) Filed: May 11, 2005

(51) Int. Cl. F26B 3/02; F26B 21/04

(52) U.S. Cl. 34/96; 392/380

(57) ABSTRACT

A handheld hair drying appliance (10) has an inlet portion (22) at one end that receives incoming airflow which is pulled in by a vacuum effect created by the rotation of a first fan blade (24) and a second fan blade (26), each coaxially aligned to rotate about a common axis. A tube-shaped sleeve (38) having a smooth, cylindrical inner surface is mounted inside of a tube portion (14) of the appliance and surrounds the motor and blade assembly such that the blade diameters are slightly smaller than the inner surface of the sleeve (34), but closely fitting, thereby optimizing vacuum pressure and air velocity to produce high output air velocity in an efficient manner.

### CROSS-REFERENCE TO RELATED APPLICATIONS

None.

### BACKGROUND OF THE INVENTION

1. Field of the Invention

The present invention relates to an apparatus for drying hair and, more particularly, to a handheld hair dryer having an electric motor, a heating element and fan blades.

2. Description of Related Art

Known handheld hairdrying appliances typically include an electric heat element and an electric motor for rotating fan blades that move air past the heat element to deliver heated, flowing air from an exit port. Various factors that affect the performance in terms of how quickly hair is dried include heat temperature, airflow rate, and air velocity. While increasing each of these factors generally improves hair drying time, there are practical limits. For instance, if the temperature of the heat is too high it can cause hair to become damaged or it can cause burn injuries or discomfort. Airflow rate is limited by cross-sectional area of the flowpath and air velocity. Since the area of the flowpath is limited by the size of the handheld appliance, it is most practical to increase air velocity. Attempts to increase air velocity include increasing the speed of the fan blade, which typically results in increased noise and a need to upgrade the electric motor to handle increased rotational velocities under load, thereby adding cost and weight.

At least one know design, described in a published United States Patent Application published as US2003079366 (“HAIR DRYER”) discloses a hair dryer with multiple fan blades and a multi-stage air current feed device to accelerate the flow velocity of the air current in the hair dryer and to reduce noise while the hair dryer is in operation. Various inlet channels at different locations form the multiple stages of the air current feed device which provide added acceleration by way of a Bernoulli effect or a Venturi effect. While such a design may improve output air velocity and decrease noise, the multi-stage air feeds introduce ambient-temperature, non-accelerated air into the airflow at positions downstream of the first or primary inlet, thus cooling the heated air and slowing the overall airflow. This counter-effect diminishes the efficiency of the motor and its velocity-generating effect and it diminishes the efficiency of the heating element. In another embodiment, the same publication discloses embodiments that do not utilize multi-stage air feeds but, instead discloses multiple, in-line fan blades and a single inlet. The embodiments disclose interior spaces where the inner walls of the flowpath have irregularities in shape and smoothness, and that have additional physical components interfering with the airflow, thus causing noise and inefficient airflow.

### OBJECTS AND BRIEF SUMMARY OF THE INVENTION

It is desirable to provide a handheld hair drying appliance that increases air velocity compared to known handheld hair drying appliances while avoiding the shortcomings described above and while achieving other benefits.

A handheld hairdrying appliance according to a preferred embodiment of the present invention comprises an electric heat element and an electric motor for rotating fan blades from a plurality of in-line fans that move air past the heat element to deliver heated, flowing air from an exit port, in addition to a tube-like sleeve with a smooth, cylindrical inner surface that has an inner diameter that closely fits around the outer diameter of the fan blades, thereby creating a smooth and efficient airflow path.

### BRIEF DESCRIPTION OF THE DRAWINGS

FIG. 1 is a partial, perspective schematic view of a hair drying appliance according to the present invention.

FIG. 2 is a side, cross-sectional schematic view of a hair drying appliance according to the present invention.

FIG. 3. is an exploded, partial schematic view of the dual coffee maker according to the present invention.

FIG. 4 is a side, cross-sectional schematic view of a hair drying appliance according to the present invention showing airflow paths.

### DETAILED DESCRIPTION OF THE PREFERRED EMBODIMENT OF THE INVENTION

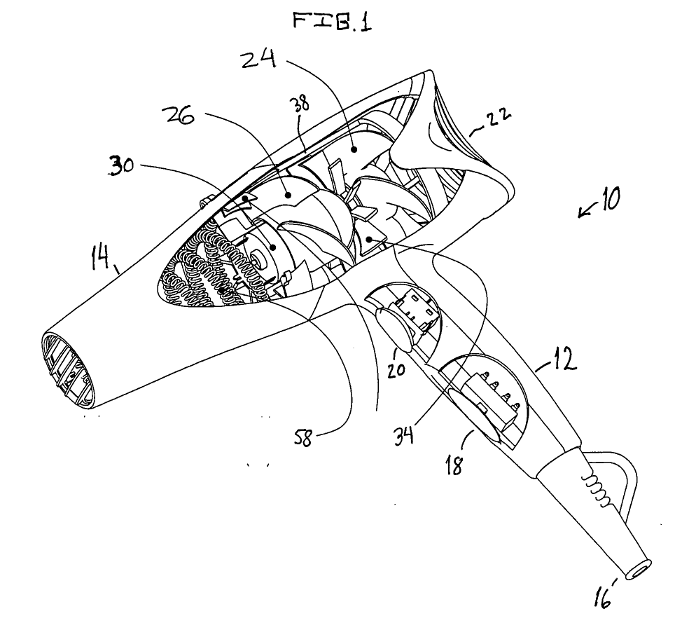

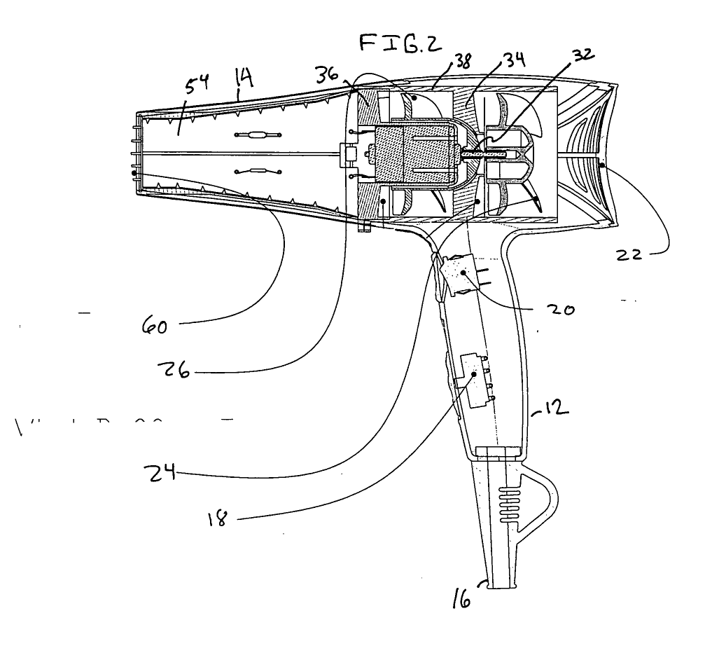

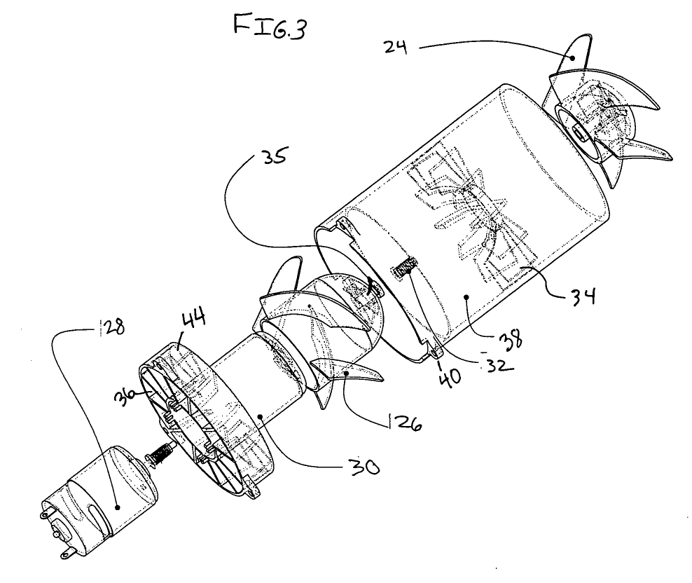

Referring to FIGS. 1-4, a hair drying appliance (10) comprises a housing having a handle portion (12) and a tube portion (14). The handle (12) includes a power cord (16), an on/off power switch (18), and a “cool-shot” control switch (20). An inlet portion (22) at one end of the tube portion (14) receives incoming airflow which is pulled in by a vacuum effect created by the rotation of a first fan blade (24) and a second fan blade (26), each coaxially aligned to rotate about a common axis. An electric motor (28) is housed in a generally cylindrical motor mount (30) from which a rotating shaft (32) extends for mounting and driving the first blade (24) and the second blade (26). A dome-shaped cap (35) is mounted to the shaft (32) near one end of the motor mount (30) for air-flow efficiency and to support the second fan blade (26). A first set of vanes (34) is mounted adjacent to and downstream of the first blade (24) and a second set of vanes (36) is mounted adjacent to and downstream of the second blade (26). A tube-shaped sleeve (38) having a smooth, cylindrical inner surface is mounted inside of the tube portion (14) by way of cooperating bosses (40, 42). A support ring (44) attached to the motor mount (30) supports the motor and blades assembly by way of a boss (46) that cooperates with the housing for mounting. The sleeve (38) surrounds the motor and blade assembly such that the blade diameters are slightly smaller than the inner surface of the sleeve (38), but closely fitting.

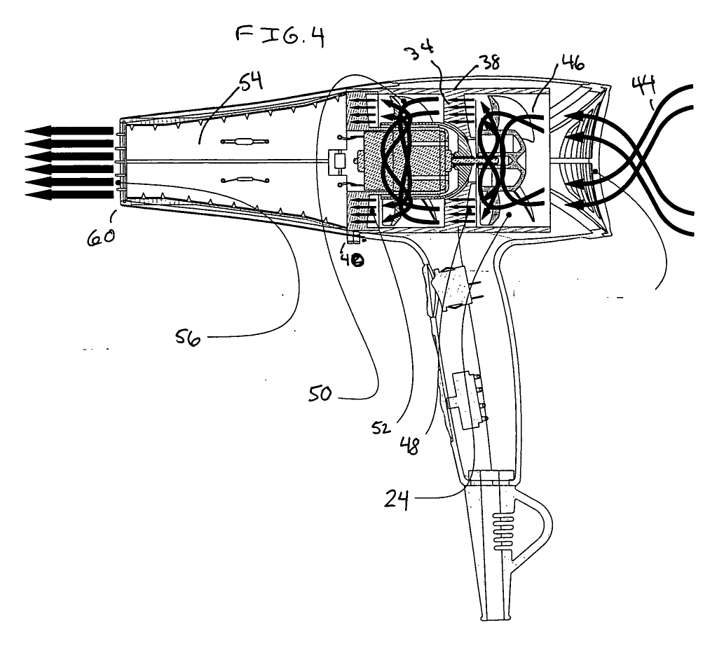

This close fit optimizes vacuum pressure created as the blades (22, 24) draw air into the sleeve (30) via the inlet portion (22), resulting in optimized air velocity. To further enhance air velocity, to two fan blades (24, 26) being in spaced, coaxial alignment sequentially accelerate air. Referring to FIG. 4, as the incoming air (44) is drawn into the inlet it is engaged by the first blade (24) which, due to its helical geometry, creates a vortex (46) while pulling the air into the sleeve (30). The first set of vanes (34) directs the air flow vortex (46) into generally linear paths (48), at a now accelerating rate, so that the air contacts the second blade (26) at an optimal angle, rather than along a vortex path. The now accelerated air (48) contacts the second blade (26) and a second vortex (50) is created. The air is already at a high velocity and high pressure (compared to its state at the inlet 22) before contacting the second blade (26) and, thus, is more efficiently accelerated by the second blade (26), and directed through the second set of vanes (36) into generally linear flow (52). From there, the airflow (52) is directed past a card (54) about which heating wires (58) are wound or another conventional heat element and directed out of a nozzle as heated, generally linear flowing air (56). The nozzle end (60) of the drying appliance may be tapered and/ or provided with vents in a variety of different ways to control air flow and speed.

In the preferred embodiment, the appliance has an on/off switch (18) and a “cool-shot” switch (20) which allows a user to selectively de-activate the heating elements to enable cooler air to flow out. Variations may include ionic and infrared emitters, and electronic or mineral type emitters such as tourmaline, or ceramic. Further variations may include fan blade speed controls, heat controls, electronic readouts and other user interface features. Additionally, the two fan blades (24, 26) may be of different dimensions and geometries and, if desired, may be driven at relatively different speeds using conventional gearing for varying output.

While the preferred embodiment of the present invention has been herein described, various modification may be made without departing from the scope of the present invention.

1) A handheld hair dryer appliance comprising
a housing;
an electric motor assembly having a rotatable output shaft;
an electric heating element;
a first fan blade mounted to said output shaft;
a second fan blade mounted to said output shaft;
an air inlet;
an air outlet; and
a sleeve mounted within said housing and surrounding said first fan blade and said second fan blade.

2) An appliance according to claim 1, further comprising
a first set of vanes located downstream of said first fan blade and within said sleeve.

3) An appliance according to claim 2, further comprising
a second set of vanes located downstream of said second fan blade.

4) An appliance according to claim 1, wherein
said first blade and said second blade are generally helically-shaped.

5) An appliance according to claim 3, wherein
said first blade and said second blade are generally helically-shaped; and
said first set of vanes and said second set of vanes are adapated, respectively, to direct airflow output passing through said respective vanes in a generally linear manner.

6) An appliance according to claim 1, wherein
said sleeve has an inner diameter of a first dimension and said first blade and said second blade each have a diameter that is slightly less than said first dimension.

7) An appliance according to claim 2, wherein
said first set of vanes is mounted to said sleeve.

8) An appliance according to claim 3, wherein
said second set of vanes is mounted to said sleeve.

9) An appliance according to claim 1, further comprising
a temperature control switch adapted to selectively cool air flowing from said appliance.

10) An appliance according to claim 1, further comprising
a generally dome-shaped blade support section mounted to said shaft and supporting said second blade.
